(19) United States
(12) Patent Application Publication
(10) Pub. No.: US 2014/0204131 A1
(43) Pub. Date: Jul. 24, 2014

(54) BACKLIGHT ADJUSTMENT METHOD, BACKLIGHT ADJUSTMENT APPARATUS, AND DISPLAY SCREEN

(71) Applicants: BEIJING BOE DISPLAY TECHNOLOGY CO., LTD., Beijing (CN); BOE TECHNOLOGY GROUP CO., LTD., Beijing (CN)

(72) Inventors: MIN CHEN, Beijing (CN); Bendeng Lv, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/144,872

(22) Filed: Dec. 31, 2013

(30) Foreign Application Priority Data
Jan. 23, 2013 (CN) 201310025277.5

(51) Int. Cl. G09G 3/36

(52) U.S. Cl. CPC G09G 3/36
USPC 345/691; 345/102

(57) ABSTRACT

The present invention is directed to a backlight adjustment method, a backlight adjustment apparatus, and a display screen. The backlight adjustment method comprises: acquiring an average brightness value of a currently-inputted image frame; converting the average brightness value into a target brightness value for a backlight; judging whether or not a difference between the target brightness value and a current brightness value of the backlight is beyond a preset range, to obtain a first judgment result; and adjusting the brightness value of the backlight according to the target brightness value when the first judgment result indicates a difference between the target brightness value and the current brightness value of the backlight which is beyond the preset range. The backlight adjustment apparatus comprises a calculation module for deriving backlight brightness adjustment by multiplying the difference in brightness value between a target value and current brightness by a preset parameter and an adjustment module which adjusts the brightness value by the adjustment step.

### CROSS REFERENCE TO RELATED APPLICATION

This application claims the benefit of CN patent application No. 201310025277.5 filed on Jan. 23, 2013, all of which is incorporated herein by reference.

### TECHNICAL FIELD

The present invention relates to the field of liquid crystal display, in particular to a backlight adjustment method, a backlight adjustment apparatus, and a display screen.

### BACKGROUND

Usually, two methods are used to adjust a backlight of a traditional liquid crystal TV. The first method is to set a backlight brightness value of the liquid crystal TV as a fixed one, usually a maximum brightness value, so the backlight brightness value of the liquid crystal TV cannot be adjusted. The second method is to dynamically adjust the backlight brightness value, i.e., the backlight brightness value changes with an average brightness value of an inputted image frame changes. An advantage of the second method is that, through an appropriate mapping curve between the average brightness value of the image frame and the backlight brightness value of the liquid crystal TV, it can improve the dynamic contrast of the liquid crystal TV, and to reduce the power consumption during the normal operation of the liquid crystal TV. A principle for dynamically adjusting the backlight is that the backlight brightness value is high when the image is bright, and the backlight brightness value is low when the image is dark. As a result, for the liquid crystal TV using the dynamic backlight adjustment technology, a light leakage phenomenon on a liquid crystal screen may be improved to some extent.

However, according to the dynamic backlight adjustment method for a traditional liquid crystal TV, as shown in FIG. 1, usually the average brightness value of the image frame is acquired, then the average brightness value is converted into a new backlight brightness value for the TV according to the mapping curve between the average brightness value of the image frame and the backlight brightness value of the liquid crystal TV, and then the backlight of the liquid crystal screen is directly adjusted. A disadvantage of such a method is that, in the event of frequent fluctuations of the average brightness values of the image frame within a small range, the backlight brightness values of the TV will change frequently and as a result, a user will obtain an uncomfortable visual feeling.

### SUMMARY

An object of the present invention is to provide a backlight adjustment method, a backlight adjustment apparatus, and a display screen, so as to prevent frequent changes of the backlight brightness value of the display screen, thereby to prevent an uncomfortable visual feeling for a user.

In one aspect, an embodiment of the present invention provides a backlight adjustment method for adjusting backlight brightness of a display screen, comprising:
acquiring an average brightness value of a currently-inputted image frame;
converting the average brightness value into a target brightness value for a backlight;
judging whether or not a difference between the target brightness value and a current brightness value of the backlight is beyond a preset range, to obtain a first judgment result; and
adjusting a brightness value of the backlight according to the target brightness value when the first judgment result indicates that the difference between the target brightness value and the current brightness value of the backlight is beyond the preset range, otherwise the brightness value of the backlight being not adjusted.

Preferably, the backlight adjustment method further comprising:
judging whether or not a current time is a time for backlight adjustment, to obtain a second judgment result; and
acquiring the average brightness value of the currently-inputted image frame when the second judgment result indicates that the current time is the time for backlight adjustment, otherwise returning to the step of judging whether or not the current time is the time for backlight adjustment.

Preferably, the step of judging whether or not the current time is the time for backlight adjustment further comprises:
calculating a time difference between the current time and a time for the last dynamic backlight adjustment, and when the time difference exceeds a system set value, determining the current time is the time for backlight adjustment, otherwise, determining the current time is not the time for backlight adjustment.

Preferably, the step of adjusting the brightness value of the backlight according to the target brightness value comprises:
adjusting the brightness value of the backlight to the target brightness value.

Preferably, the step of adjusting the brightness value of the backlight according to the target brightness value comprises:
multiplying a difference between the target brightness value and the current brightness value of the backlight by a preset parameter, to obtain a backlight brightness adjustment step;
calculating a sum of the current brightness value of the backlight and the backlight brightness adjustment step; and
adjusting the brightness value of the backlight to the sum.

Preferably, the preset parameter is smaller than 1 and larger than 0.

An embodiment of the present invention further provides a backlight adjustment apparatus for adjusting backlight brightness of a display screen, comprising:
an acquisition module configured to acquire an average brightness value of a currently-inputted image frame;
a conversion module configured to convert the average brightness value into a target brightness value for a backlight;
a first judgment module configured to judge whether or not a difference between the target brightness value and a current brightness value of the backlight is beyond a preset range, to obtain a first judgment result; and
a backlight adjustment module configured to adjust a brightness value of the backlight according to the target brightness value when the first judgment result indicates that the difference between the target brightness value and the current brightness value of the backlight is beyond the preset range, otherwise the brightness value of the backlight being not adjusted.

Preferably, the backlight adjustment apparatus further comprising:
a second judgment module configured to judge whether or not a current time is a time for backlight adjustment, to obtain a second judgment result,
wherein the acquisition module is configured to acquire the average brightness value of the currently-inputted image frame when the second judgment result indicates that the current time is the time for backlight judgment.

Preferably, the second judgment module calculates a time difference between the current time and a time for the last dynamic backlight adjustment, and when the time difference exceeds a system set value, determines the current time is the time for backlight adjustment, otherwise, determines the current time is not the time for backlight adjustment.

Preferably, the backlight adjustment module is configured to adjust the brightness value of the backlight to the target brightness value.

Preferably, the backlight adjustment module comprises:
an adjustment step calculation module configured to multiply a difference between the target brightness value and the current brightness value of the backlight by a preset parameter, to obtain a backlight brightness adjustment step;
a sum calculation module configured to calculate a sum of the current brightness value of the backlight and the backlight brightness adjustment step; and
a backlight adjustment sub-module configured to adjust the brightness value of the backlight to the sum.

An embodiment of the present invention further provides a display screen, comprising a backlight and the above mentioned backlight adjustment apparatus.

The present invention has at least one of the following advantageous effects.

According to an embodiment of the present invention, it can prevent frequent changes of the backlight brightness value of the display screen, and prevent slow response of the display screen. In addition, according to an embodiment of the present invention, when the average brightness values of the image frame is dramatically changed within a large range, the backlight brightness value of the display screen will not be changed dramatically and as a result, it is able to prevent an uncomfortable visual feeling for a user.

### BRIEF DESCRIPTION OF THE DRAWINGS

FIG. 1 is a schematic structure diagram showing a backlight adjustment apparatus in the prior art;

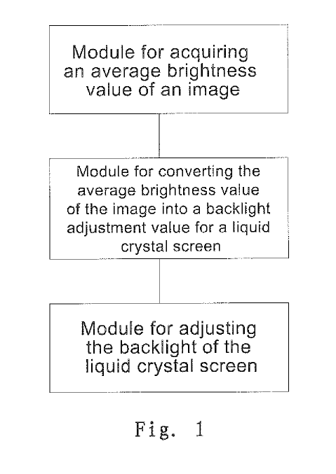

FIG. 2 is a flow chart showing a backlight adjustment method according to an embodiment of the present invention; and

FIG. 3 is a schematic structure diagram showing a backlight adjustment apparatus according to an embodiment of the present invention.

### DETAILED DESCRIPTION

To make the objects, the technical solutions and the advantages of the present invention to be more apparent, the present invention will be descried hereinafter in conjunction with the drawings as well as the embodiments.

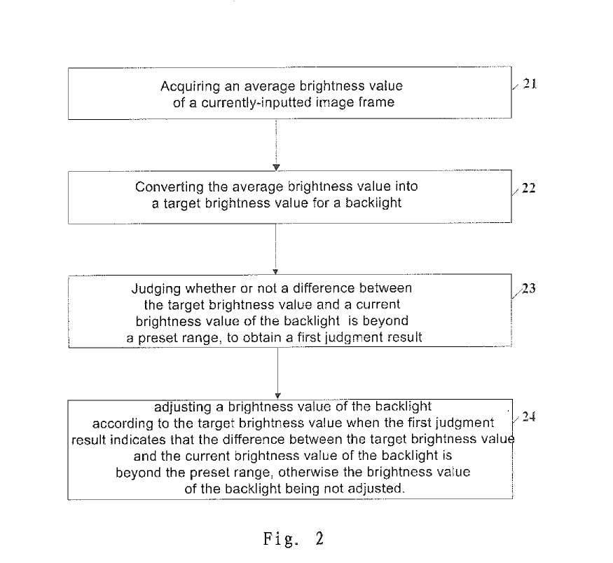

The present invention provides a backlight adjustment method for adjusting backlight brightness value of a display screen. As shown in FIG. 2, the backlight adjustment method comprises:

Step 21: acquiring an average brightness value of a currently-inputted image frame;

Step 22: converting the average brightness value into a target brightness value for a backlight;

Step 23: judging whether or not a difference between the target brightness value and a current brightness value of the backlight is beyond a preset range, to obtain a first judgment result; and

Step 24: adjusting the brightness value of the backlight according to the target brightness value when the first judgment result indicates that the difference between the target brightness value and the current brightness value of the backlight is beyond the preset range, otherwise the brightness value of the backlight being not adjusted.

According to the backlight adjustment method in an embodiment of the present invention, the brightness value of the backlight is adjusted according to the target brightness value only when the difference between the target brightness value and the current brightness value of the backlight is beyond the preset range. As a result, it can achieve the object of an embodiment of the present invention, i.e., to prevent frequent changes of the backlight brightness when the average brightness value of the image frame is frequently fluctuated within a small range.

Following are the examples how the backlight adjustment method can prevent frequent changes of the backlight brightness value of the display screen.

### Example 1

Presumed that the current brightness value of the backlight is 100 and the preset range is [−5, 5], when the target brightness values fluctuate frequently between 95 and 105, the brightness value of the backlight is not adjusted according to the target brightness value and the current brightness value of the backlight is always maintained at 100, because the difference between the target brightness value and the current brightness value is within the preset range.

Hence, the backlight adjustment method according to an embodiment of the present invention can prevent frequent changes of the backlight brightness value of the display screen.

In addition, when adjusting the backlight, frequent collection of the average brightness values of the inputted image frame will lead to excessive consumption of system resources, and further lead to slow response of the display screen. To solve this problem, the backlight adjustment method further comprises:
judging whether or not a current time is a time for backlight adjustment, to obtain a second judgment result; and
proceeding to Step 21 when the second judgment result indicates that the current time is the time for backlight adjustment, and
otherwise returning the step of judging whether or not the current time is the time for backlight adjustment.

According to the backlight adjustment method, the second judgment result is obtained by judging whether or not the current time is the time for backlight adjustment, and the average brightness value of the currently-inputted image frame is obtained only when the second judgment result indicates that the current time is the time for backlight adjustment. Otherwise, the procedure returns to the step of judging whether or not the current time is the time for backlight adjustment, until it proceeds to Step 21. As a result, it can prevent excessive consumption of the system resources due to frequent collection of the average brightness values of the inputted image frame, and further to prevent slow response of the display screen. Following is an example.

### Example 2

Presumed that the time for backlight adjustment is reached at a regular interval T, after acquiring the average brightness value of the currently-inputted image frame at a time T1, the system will not immediately acquire the average brightness value of the image frame inputted at a next time. Instead, the system judges whether or not the current time is the time for backlight adjustment, i.e., whether or not an interval between the current time and T1 is T, and after the interval reaches T, it starts to acquire the average brightness value of the image frame inputted at this time.

As a result, the backlight adjustment method may prevent excessive consumption of the system resources due to the frequent collection of the average brightness values of the image frame, thereby to prevent slow response of the display screen.

Further, the present invention provides the following implementation modes to judge whether or not the current time is the time for backlight adjustment.

Implementation Mode 1

In this mode, the backlight adjustment method comprises acquiring a current time, calculating a difference between the current time and a time for the last dynamic backlight adjustment, and when the difference exceeds a set value for the system, determining the current time is the time for backlight adjustment.

When the difference between the current system time and the time for the last dynamic backlight adjustment is calculated and the difference exceeds the set value for the system, the current time is the time for backlight adjustment. At this time, the procedure proceeds to Step 21. The interval for acquiring the average brightness values of the inputted image frames can be controlled by the set value for the system, and as a result, it can prevent excessive consumption of the system resources due to the frequent collection of the average brightness values of the image frames, and further to prevent slow response of the display screen. Meanwhile, the present invention further provides another implementation mode to judge whether or not the current time is the time for backlight adjustment as follows.

Implementation Mode 2

In this mode, a timer is provided. The timer is started from the time for the last dynamic backlight adjustment, and when it is timed out, the current time is the time for backlight adjustment.

The above are merely the preferred implementation modes to judge whether or not the current time is the time for backlight adjustment. Of course, the other modes may also be used, and they are not elaborated herein.

In the backlight adjustment method according to an embodiment of the present invention, Step 21 may be implemented in various modes. When the method is applied to a liquid crystal TV, Step 21 preferably includes acquiring a brightness value of each pixel of the inputted image frame by reading a register of an image processing unit in a main control chip of the liquid crystal TV, and calculating a real-time average brightness value of the whole image frame.

In the backlight adjustment method according to an embodiment of the present invention, Step 22 preferably includes converting the acquired real-time average brightness value into a target brightness value for a backlight to be adjusted according to a mapping curve between the average brightness value of the image frame and the backlight brightness value of the liquid crystal screen.

Preferably, Step 24 may be implemented in the following modes.

Implementation Mode 1

Step 24 includes adjusting the brightness value of the backlight to the target brightness value when the difference between the target brightness value and the current brightness value of the backlight is beyond the preset range.

In this mode, the brightness value of the backlight is adjusted to the target brightness value. The backlight brightness value of the display screen can be adjusted accurately.

Implementation Mode 2

If two adjacent backlight brightness values change dramatically within a large range, the backlight brightness value of the display screen will be changed dramatically, which thereby leads to an uncomfortable visual feeling for the user. To solve this problem, an embodiment of the present invention provides another implementation mode for Step 24, which comprises:
multiplying the difference between the target brightness value and the current brightness value of the backlight by a preset parameter, to obtain a backlight brightness adjustment step;
calculating a sum of the current brightness value of the backlight and the backlight brightness adjustment step; and
adjusting the brightness value of the backlight to the sum.

To be specific, the difference between the target brightness value and the current brightness value of the backlight is multiplied by the preset parameter (larger than 0 and less than 1) to obtain a backlight brightness adjustment step, and the backlight brightness adjustment step is added to the current brightness value to obtain a sum, and then the brightness value of the backlight is adjusted to the sum. A speed of gradual change of the backlight brightness may be controlled by multiplying the difference between the real-time backlight brightness value and the current backlight brightness value by the preset parameter, so as to prevent a sudden change of the backlight brightness value of the display screen, thereby to further prevent an uncomfortable visual feeling for the user.

Following is an example for the above two implementation modes.

### Example 3

Presumed that the target brightness value is 100, in the first implementation mode, a change of the difference between the target brightness value and the current brightness value is not taken into consideration, and the brightness value of the backlight will be directly adjusted to 100.

If the current brightness value is 10, i.e., the difference between the target brightness value and the current brightness value is too big, the second implementation mode will be used to adjust the brightness value of the backlight. Presumed that the preset parameter is 0.4, the difference between the target brightness value and the current brightness value is multiplied by the preset parameter to obtain a backlight brightness adjustment step of 36, and the backlight brightness adjustment step is added to the current backlight brightness value to obtain a sum of 46. At this time, the brightness value of the backlight can be adjusted to 46.

If the brightness value of the backlight is directly adjusted to the target brightness value, i.e., 100, the backlight brightness value of the display screen will be changed dramatically. However, in the second implementation mode, it is merely required to adjust the brightness value of the backlight to 46, so it may prevent sudden change of the backlight brightness value of the display screen.

The adjustment of the brightness value of the backlight according to the real-time backlight brightness value is not limited to the above two modes, and the other modes are not elaborated herein.

When the backlight brightness value of the display screen is adjusted through the above modes, preferably a duty ratio of a PWM signal may be adjusted according to the target brightness value or the sum, so as to control a voltage change of the backlight, thereby to change the backlight brightness value of the liquid crystal screen.

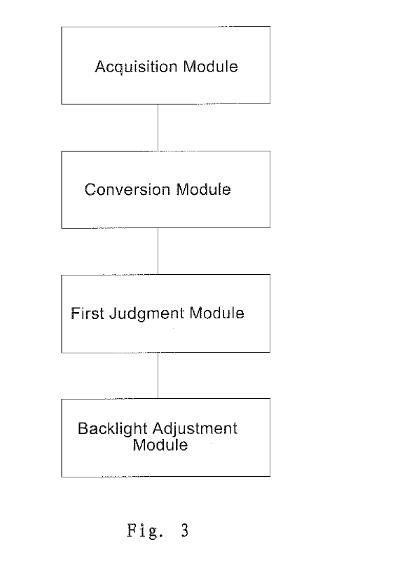

An embodiment of the present invention further provides a backlight adjustment apparatus for adjusting the backlight brightness value of a display screen. As shown in FIG. 3, the backlight adjustment apparatus comprises:
an acquisition module configured to acquire an average brightness value of a currently-inputted image frame;
a conversion module configured to convert the average brightness value into a target brightness value for a backlight;
a first judgment module configured to judge whether or not a difference between the target brightness value and a current brightness value of the backlight is beyond a preset range, to obtain a first judgment result; and
a backlight adjustment module configured to adjust the brightness value of the backlight according to the target brightness value when the first judgment result indicates that the difference between the target brightness value and the current brightness value of the backlight is beyond the preset range.

Preferably, the backlight adjustment apparatus further comprises:
a second judgment module configured to judge whether or not a current time is a time for backlight adjustment, to obtain a second judgment result,
wherein the acquisition module is specifically configured to acquire the average brightness value of the currently-inputted image frame when the second judgment result indicates that the current time is the time for backlight judgment.

Preferably, the backlight adjustment module is specifically configured to adjust the brightness value of the backlight to the target brightness value.

Preferably, the backlight adjustment module specifically comprises:
an adjustment step calculation module configured to multiply a difference between the target brightness value and the current brightness value of the backlight by a preset parameter, to obtain a backlight brightness adjustment step;
a sum calculation module configured to calculate a sum of the current brightness value of the backlight and the backlight brightness adjustment step; and
a backlight adjustment sub-module configured to adjust the brightness value of the backlight to the sum.

According to the backlight adjustment method and the backlight adjustment apparatus of the embodiments of the present invention, it may not only prevent frequent change of the backlight brightness when the average brightness values of the image frame is frequently fluctuated within a small range, but also prevent slow response of the display screen due to frequent collection of the average brightness values of the image frame. Meanwhile, when the average brightness values of the image frames change dramatically within a large range, it may prevent sudden change of the backlight brightness value of the display screen, thereby to further prevent an uncomfortable visual feeling for a user. When the method is used to solve all of the above problems, one of the implementation modes includes the following steps.

Step 1: the backlight adjustment apparatus judges whether or not the current time is the time for backlight adjustment, to obtain a second judgment result. To be specific, whether or not the current time is the time for backlight adjustment can be determined by judging whether or not a difference between the times for executing two adjacent dynamic backlight processing functions exceeds a preset value A.

Step 2: when the second judgment result indicates that the difference between the times for executing two adjacent dynamic backlight processing functions exceeds the preset value A, i.e., when the current time is the time for backlight adjustment, the backlight adjustment apparatus acquires an average brightness value of the image frame. At this time, the backlight adjustment apparatus may acquire the brightness value of each pixel of the image frame by reading a register of an image processing unit in a main control chip of the liquid crystal TV, and calculate the average brightness value of the whole image frame. Then, the procedure proceeds to Step 3.

When the second judgment result indicates that the difference between the times for executing two adjacent dynamic backlight processing functions does not exceed the preset value A, i.e., when the current time is not the time for backlight adjustment yet, the procedure returns to Step 1. As a result, it can present slow response of the display screen due to frequent collection of the average brightness values of the image frames.

Step 3: the backlight adjustment apparatus coverts the acquired average brightness value of the image frame into the target brightness value desired for the backlight according to a mapping curve between the average brightness value of the image frame and the backlight brightness value of the liquid crystal screen.

Step 4: the backlight adjustment apparatus continues to judge whether or not a difference between the target brightness value and the current brightness value of the backlight is beyond a preset range B, to obtain a first judgment result.

Step 5: when the first judgment result indicates that the difference between the target brightness value and the current brightness value of the backlight is beyond the preset range B, the backlight adjustment apparatus multiplies the difference between the target brightness value and the current brightness value of the backlight by a preset parameter C, to obtain a backlight brightness adjustment step. As a result, it may prevent sudden change of the backlight brightness value of the display screen when the average brightness value of the currently-inputted image frame is dramatically changed within a large range.

When the first judgment result indicates that the difference between the target brightness value and the current brightness value of the backlight is within the preset range B, the procedure returns to Step 4. As a result, it may prevent frequent change of the backlight brightness when the average brightness value of the inputted image frame is frequently fluctuated within a small range.

Step 6: the backlight adjustment apparatus calculates a sum of the current brightness value of the backlight and the backlight brightness adjustment step.

Step 7: the backlight adjustment apparatus adjusts the brightness value of the backlight to the sum. Certainly, under the condition that the change of the difference between the target brightness value and the current brightness value is not under consideration, the brightness value of the backlight may be directly adjusted to the target brightness value. A duty ratio of a PWM signal is adjusted according to the sum or the target brightness value, so as to control a voltage change of the backlight, thereby o change the backlight brightness value of the liquid crystal screen.

The preset parameter A is used to control the time interval for acquiring the average brightness value of the image frame, the preset range B is used to control the response sensitivity of the backlight brightness value, and the preset parameter C is used to control a speed of gradual change of the backlight brightness value.

According to the above procedure, by setting the time interval for acquiring the average brightness value of the image frame, judging the difference between the two adjacent backlight brightness values, and dynamically setting the step for each backlight adjustment value, it can improve the slow response during the dynamic backlight adjustment and a flickering phenomenon on a liquid crystal TV, thereby to improve the visual feeling of the user.

An embodiment of the present invention further provides a display screen comprising a backlight and the above-mentioned backlight adjustment apparatus.

The above are merely the preferred embodiments of the present invention. It should be noted that, a person skilled in the art may make further improvements and modifications without departing from the principle of the present invention, and these improvements and modifications shall also be considered as the scope of the present invention.

What is claimed is:

1. A backlight adjustment method for adjusting backlight brightness of a display screen, comprising:
acquiring an average brightness value of a currently-inputted image frame;
converting the average brightness value into a target brightness value for a backlight;
judging whether or not a difference between the target brightness value and a current brightness value of the backlight is beyond a preset range, to obtain a first judgment result; and
adjusting a brightness value of the backlight according to the target brightness value when the first judgment result indicates that the difference between the target brightness value and the current brightness value of the backlight is beyond the preset range, otherwise the brightness value of the backlight being not adjusted.

2. The backlight adjustment method according to claim 1, further comprising:
judging whether or not a current time is a time for backlight adjustment, to obtain a second judgment result; and
acquiring the average brightness value of the currently-inputted image frame when the second judgment result indicates that the current time is the time for backlight adjustment, otherwise returning to the step of judging whether or not the current time is the time for backlight adjustment.

3. The backlight adjustment method according to claim 2, the step of judging whether or not the current time is the time for backlight adjustment further comprises:
calculating a time difference between the current time and a time for the last dynamic backlight adjustment, and when the time difference exceeds a system set value, determining the current time is the time for backlight adjustment, otherwise, determining the current time is not the time for backlight adjustment.

4. The backlight adjustment method according to claim 1, wherein the step of adjusting the brightness value of the backlight according to the target brightness value comprises:
adjusting the brightness value of the backlight to the target brightness value.

5. The backlight adjustment method according to claim 1, wherein the step of adjusting the brightness value of the backlight according to the target brightness value comprises:
multiplying a difference between the target brightness value and the current brightness value of the backlight by a preset parameter, to obtain a backlight brightness adjustment step;
calculating a sum of the current brightness value of the backlight and the backlight brightness adjustment step; and
adjusting the brightness value of the backlight to the sum.

6. The backlight adjustment method according to claim 5, wherein the preset parameter is smaller than 1 and larger than 0.

7. A backlight adjustment apparatus for adjusting backlight brightness of a display screen, comprising:
an acquisition module configured to acquire an average brightness value of a currently-inputted image frame;
a conversion module configured to convert the average brightness value into a target brightness value for a backlight;
a first judgment module configured to judge whether or not a difference between the target brightness value and a current brightness value of the backlight is beyond a preset range, to obtain a first judgment result; and
a backlight adjustment module configured to adjust a brightness value of the backlight according to the target brightness value when the first judgment result indicates that the difference between the target brightness value and the current brightness value of the backlight is beyond the preset range, otherwise the brightness value of the backlight being not adjusted.

8. The backlight adjustment apparatus according to claim 7, further comprising:
a second judgment module configured to judge whether or not a current time is a time for backlight adjustment, to obtain a second judgment result,
wherein the acquisition module is configured to acquire the average brightness value of the currently-inputted image frame when the second judgment result indicates that the current time is the time for backlight judgment.

9. The backlight adjustment apparatus according to claim 8, wherein the second judgment module calculates a time difference between the current time and a time for the last dynamic backlight adjustment, and when the time difference exceeds a system set value, determines the current time is the time for backlight adjustment, otherwise, determines the current time is not the time for backlight adjustment.

10. The backlight adjustment apparatus according to claim 7, wherein
the backlight adjustment module is configured to adjust the brightness value of the backlight to the target brightness value.

11. The backlight adjustment apparatus according to claim 7, wherein the backlight adjustment module comprises:
an adjustment step calculation module configured to multiply a difference between the target brightness value and the current brightness value of the backlight by a preset parameter, to obtain a backlight brightness adjustment step;
a sum calculation module configured to calculate a sum of the current brightness value of the backlight and the backlight brightness adjustment step; and
a backlight adjustment sub-module configured to adjust the brightness value of the backlight to the sum.

12. The backlight adjustment apparatus according to claim 11, wherein the preset parameter is smaller than 1 and larger than 0.

13. A display screen, comprising a backlight and the backlight adjustment apparatus according claim 7.

14. The display screen according to claim 13, wherein the backlight adjustment apparatus further comprises:
a second judgment module configured to judge whether or not a current time is a time for backlight adjustment, to obtain a second judgment result,
wherein the acquisition module is configured to acquire the average brightness value of the currently-inputted image frame when the second judgment result indicates that the current time is the time for backlight judgment.

15. The display screen according to claim 14, wherein the second judgment module calculates a time difference between the current time and a time for the last dynamic backlight adjustment, and when the time difference exceeds a system set value, determines the current time is the time for backlight adjustment, otherwise, determines the current time is not the time for backlight adjustment.

16. The display screen according to claim 13, wherein
the backlight adjustment module is configured to adjust the brightness value of the backlight to the target brightness value.

17. The display screen according to claim 13, wherein the backlight adjustment module comprises:
an adjustment step calculation module configured to multiply a difference between the target brightness value and the current brightness value of the backlight by a preset parameter, to obtain a backlight brightness adjustment step;
a sum calculation module configured to calculate a sum of the current brightness value of the backlight and the backlight brightness adjustment step; and
a backlight adjustment sub-module configured to adjust the brightness value of the backlight to the sum.

18. The display screen according to claim 17, wherein the preset parameter is smaller than 1 and larger than 0.
